(19) United States
(12) Patent Application Publication
(10) Pub. No.: US 2025/0025969 A1
(43) Pub. Date: Jan. 23, 2025

(54) Flux and solder paste comprising said flux

(71) Applicant: Heraeus Electronics GmbH & Co. KG

(72) Inventors: Steffen KÄSS, Hanau (DE); Michael NEIDERT, Hanau (DE); Christian LOOSZ, Hanau (DE)

(21) Appl. No.: 18/772,945

(22) Filed: Jul. 15, 2024

(30) Foreign Application Priority Data
Jul. 20, 2023 (EP) 23186570.0

(51) Int. Cl. B23K 35/36; B23K 35/02

(52) U.S. Cl. CPC B23K 35/3613; B23K 35/025

(57) ABSTRACT

A flux, consisting of: (i) 30 to 80 wt. % of one or more acidic (meth)acrylic copolymers having an acid number in the range from 100 to 350 mg KOH/g and having a weight-average molecular weight M_{w} in the range from 1000 to 5000; (ii) 10 to 60 wt. % of at least one organic solvent; (iii) 0 to 15 wt. % of one or more amines; and, (iv) 0 to 20 wt. % of one or more components other than components (i) to (iii); and solder paste consisting of 80 to 92 wt. % of one or more different solders and 8 to 20 wt. % of the flux.

### CROSS-REFERENCE TO RELATED APPLICATIONS

This application claims priority pursuant to 35 U.S.C. 119(a) to European Application No. 23186570.0, filed Jul. 20, 2023, which application is incorporated herein by reference in its entirety.

### FIELD

The present invention relates to a flux for solder pastes and to a solder paste comprising the flux, in particular for attaching electronic components to substrates.

### BACKGROUND

Solder pastes, in particular soft solder pastes, are mainly used in the production of electronic circuits and are used to create a mechanical, electrical and thermal connection between an electronic component and a substrate, or more precisely, between the contact surfaces of the latter intended for this purpose.

Examples of electronic components within the meaning of the present patent application comprise diodes, LEDs (light emitting diodes), dies, IGBTs (insulated-gate bipolar transistors), MOSFETs (metal-oxide-semiconductor field-effect transistors), ICs (integrated circuits), sensors, heat sinks, resistors, capacitors, coils, connecting elements (e.g., clips), base plates, antennas, and the like.

Examples of substrates within the meaning of the present patent application comprise lead frames, PCBs (printed circuit boards), flexible electronics, ceramic substrates, metal-ceramic substrates, such as DCB substrates (direct copper-bonded substrates), IMS (insulated metal substrate) and the like.

The electronic component is typically brought into contact with or applied to the substrate via the solder paste. The solder paste is heated in order to melt the solder (solder metal, solder alloy) in the paste by means of a reflow process, for example. After the solder has cooled and solidified, the electronic component and substrate are firmly bonded together.

In addition to solder powder, solder pastes typically contain flux. Fluxes are used, among other things, to dissolve the oxide layer on the surfaces of the solder powder, the electronic component and the substrate and thus ensure better wettability during the soldering process.

Fluxes that form part of solder pastes are typically based on natural resins, such as colophony in particular. Furthermore, organic solvents, buffering bases, such as amines, and activators, such as carboxylic acids or halogen compounds, are typically contained as components in such fluxes.

### SUMMARY

The object of the invention is to provide a solder paste with improved viscosity and thus with improved storage stability and preferably also with improved solderability in the presence of air, i.e., with good solderability, even without having to take special measures to exclude atmospheric oxygen, such as vacuum soldering or soldering under inert gas. High viscosity stability, in turn, goes hand in hand with consistent processability, such as, in particular, consistent printability.

The applicant was able to develop a flux that solves the problem, or rather a solder paste comprising the flux that solves the problem. Accordingly, the invention consists in providing a flux consisting of
(i) 30 to 80 wt. % (% by weight), preferably 35 to 70 wt. %, of one or more acidic (meth)acryl copolymers having an acid number in the range from 100 to 350 mg KOH/g and having a weight-average molecular weight M_{w} in the range from 1000 to 5000,
(ii) 10 to 60 wt. %, preferably 20 to 50 wt. %, of at least one organic solvent,
(iii) 0 to 15 wt. %, preferably 4 to 12 wt. %, of one or more amines,
(iv) 0 to 20 wt. % of one or more components other than components (i) to (iii).

### DESCRIPTION

“(Meth)acrylic” means “methacrylic” and/or “acrylic.”

The term “acid number” used in this description and in the examples refers to an acid number (SZ) that can be determined in mg KOH/g (milligrams KOH per gram) in accordance with DIN EN ISO 2114.

Unless otherwise stated, all standards cited in this description and in the examples are the version prevailing at the time of the priority date of the present patent application.

The weight-average molecular weight M_{w} mentioned in this description and in the examples can be determined in the usual manner known to the person skilled in the art by means of GPC, for example according to DIN 55672-1 (March 2016; crosslinked polystyrene as immobile phase, tetrahydrofuran as liquid phase, polystyrene standards, 23° C.).

Depending on the presence of components (iii) and/or (iv), the flux may accordingly consist of components (i) plus (ii) or (i) plus (ii) plus (iii) or (i) plus (ii) plus (iv) or (i) plus (ii) plus (iii) plus (iv) and in each of these alternatives the sum of the wt. % of the respective components is 100 wt. %.

As component (i), the flux according to the invention comprises 30 to 80 wt. %, preferably 35 to 70 wt. %, of one or more different acidic (meth)acrylic copolymers. Preferably it is only one acidic (meth)acrylic copolymer. The acidic (meth)acrylic copolymer(s) have an acid number in the range from 100 to 350 mg KOH/g, preferably from 150 to 300 mg KOH/g. The acidic (meth)acrylic copolymer or copolymers have a weight-average molecular weight M_{w} in the range from 1000 to 5000, preferably in the range from 1000 to 3000 and in particular in the range from 1500 to 2500. Acidic (meth)acrylic copolymers having an acid number in the range from 150 to 300 mg KOH/g and a weight-average molecular weight M_{w} in the range from 1000 to 3000 or from 1500 to 2500 are preferred. These are copolymers of (meth)acrylic compounds which can be prepared in the usual manner known to the person skilled in the art by radical copolymerization, it also being possible for the copolymers to comprise comonomers other than those of the (meth)acrylic type, such as vinyl compounds and/or other olefinically unsaturated radical copolymerizable compounds, in a total proportion by weight of <50 wt. %, based on total acidic (meth)acrylic copolymer. Examples of the (meth)acrylic compounds which make up >50% by weight, based on total (meth)acrylic copolymer, are (meth)acrylic acid, (meth)acrylic acid esters and (meth)acrylamides. Examples of vinyl compounds comprise compounds such as vinyl ester, vinyl ether, styrene and the like.

It is preferred if the acidic (meth)acrylic copolymer(s) have a glass transition temperature (T_{g}) in the range of >0° C., but generally <105° C. The glass transition temperature can be determined using dynamic differential scanning calorimetry (DSC) based on DIN 51007 with a heating rate of 10K/min.

Acidic (meth)acrylic copolymers of the type explained above are commercially available. Examples thereof can be found as products labeled Indurez from Indulor Chemie GmbH and as products labeled Joncryl® from BASF.

As component (ii), the flux according to the invention comprises 10 to 60 wt. %, preferably 20 to 50 wt. %, of at least one organic solvent. Examples comprise diols, alcohols, ether alcohols and ketones which are liquid at 25° C., in particular trimethylpropanol, 1,2-octanediol, 1,8-octanediol, 2,5-dimethyl-2,5-hexanediol, isobornylcyclohexanol, glycol ether, 2-ethyl-1,3-hexanediol, n-decyl alcohol, 2-methyl-2,4-pentanediol, terpineol and isopropanol as well as mixtures thereof. Examples of glycol ethers comprise mono-, di-, tripropylene glycol methyl ethers, mono-, di-, tripropylene glycol n-butyl ethers, mono-, di-, triethylene glycol n-butyl ethers, ethylene glycol dimethyl ethers, triethylene glycol methyl ethers, diethylene glycol dibutyl ethers, tetraethylene glycol dimethyl ethers and diethylene glycol monohexyl ethers, as well as mixtures thereof.

As component (iii), the flux according to the invention comprises 0 to 15 wt. %, preferably 4 to 12 wt. % of one or more amines, i.e., the flux according to the invention may comprise one or more amines or be free thereof, preferably one or more amines are comprised. Examples of amines comprise N,N,N′,N′-tetramethylethylenediamine, N,N,N′,N′-tetraethylethylenediamine, N,N,N′,N′-tetrapropylethylenediamine, N-coco-1,3-diaminopropane, 1,6-diaminohexane, 1,7-diaminoheptane, 1,8-diaminooctane, 1,9-diaminononane and 1,10-diaminodecane, bis(2-ethylhexyl)amine, bis(2-methylhexyl)amine, diethylamine, triethylamine, cyclohexylamine, diethanolamine, triethanolamine, hydrogenated tallow-alkylamine, hydrogenated (tallow-alkyl)dimethylamine and hydrogenated bis(tallow-alkyl)methylamine.

As component (iv), the flux according to the invention comprises 0 to 20 wt. % of one or more components that differ from components (i) to (iii), i.e., the flux according to the invention may comprise one or more type (iv) components or be free thereof. Examples of type (iv) ingredients comprise in particular thickening agents, but may also comprise activators, defoamers, wetting aids and/or stabilizers.

Examples of thickening agents comprise ethyl cellulose, hydrogenated castor oil, glycerol-tris-12-hydroxystearin and modified glycerol-tris-12-hydroxystearin.

Examples of low-molecular-weight carboxylic acids which can be used as activators comprise benzilic acid, oxalic acid, adipic acid, malonic acid, succinic acid, glutaric acid, pimelic acid, cork acid, azelaic acid, sebacic acid, undecanedioic acid, dodecanedioic acid and tridecanedioic acid. It may be expedient for the flux according to the invention to comprise 2 to 15 wt. % of at least one low-molecular-weight carboxylic acid as a type (iv) component; in the case of such an embodiment, a maximum of 5 to 18 wt. % of further type (iv) components, but different from low molecular weight carboxylic acids, may accordingly be comprised by the flux according to the invention.

Examples of halogen-containing compounds useful as activators comprise aniline hydrochloride, glutamic acid hydrochloride, diethanolamine hydrochloride, diethanolamine hydrobromide, triethanolamine hydrochloride, triethanolamine hydrobromide and trans-2,3-dibromo-2-butene-1,4-diol.

Preferably, the flux according to the invention, i.e., the entire flux consisting of the components (i) plus (ii) or (i) plus (ii) plus (iii) or (i) plus (ii) plus (iv) or (i) plus (ii) plus (iii) plus (iv), has a flux acid number (FMSZ) in the range from 100 to 250 mg KOH/g, preferably in the range from 120 to 220 mg KOH/g. The flux acid number mentioned in this description and in the examples can be determined in accordance with IPC TM-650 2.3.13 (dated June 2004 Revision A). The flux acid number is formed at least substantially or completely from the carboxyl groups of component (i) and the carboxyl groups optionally contributed by component (iv).

The invention further comprises providing a solder paste comprising 80 to 92 wt. % of one or more different solders and 8 to 20 wt. % of a flux according to the invention, i.e., a flux according to the invention in one of its aforementioned embodiments. The sum of the percentages by weight of the solder(s) and of the flux according to the invention is 100 wt. %.

As mentioned, the solder paste according to the invention comprises 80 to 92 wt. % of one or more different solders, in particular solder(s) based on tin (solder alloys comprising at least 80 wt. %, preferably at least 83 wt. %, in particular 90 to 99.5 wt. % tin) or based on bismuth/tin (solder alloys comprising 50 to 60 wt. % bismuth and 40 to 50 wt. % tin).

It is preferred that the solder has a liquidus temperature in a range from 150 to 350° C., preferably in a range from 180 to 300° C.

The solder or solders are present in the solder paste according to the invention as solder powder, as is usual for solder pastes. The ball size of the solder balls making up the solder powder can correspond to any of the classifications according to the IPC J-STD-005A standard, i.e., the solder paste according to the invention can have solder balls of any type of ball size within the type range T1 to T7.

Preferably, the solder paste according to the invention has a viscosity of 50 to 250 Pa·s. The viscosity mentioned in this description and in the examples can be determined using a plate-plate rheometer having a plate diameter of 50 mm and a measuring gap of 400 μm (for example the plate-plate rheometer Physica MCR 150 from Anton-Paar) at 25° C. and at a shear rate of 10 s⁻¹.

A further object of the present invention is a method for producing a solder paste according to the invention.

The method for producing a solder paste according to the invention comprises the following steps:
mixing the components of a flux according to the invention; and
adding a solder powder as mentioned above.

The solder powder is preferably added, in multiple portions while stirring, to a prepared mixture of the components of the flux according to the invention, generally without heating.

The solder paste according to the invention can be used to connect electronic components to substrates. It can also be used to produce solder deposits on substrates.

When connecting electronic components to substrates, the contact surface of the substrate and the contact surface of the electronic component are bonded via the solder paste according to the invention.

A method of attaching an electronic component to a substrate using a solder paste according to the invention may comprise the following steps:
a) providing an electronic component with a contact surface,
b) providing a substrate with a contact surface,
c) applying the solder paste to the contact surface of the electronic component and/or the contact surface of the substrate,
d) bonding the contact surface of the electronic component to the contact surface of the substrate using the solder paste; and
e) heating the solder paste above the liquidus temperature of the solder and then allowing the solder to cool and solidify, forming a firm bond between the electronic component and the substrate.

Steps a) and b) are self-explanatory and require no further explanation.

In step c), the solder paste according to the invention can be applied to one or both contact surfaces by means of conventional methods known to the skilled person, for example by screen or stencil printing or dispensing or jetting.

In step d), the contact surfaces of the electronic component and of the substrate can be bonded together using the solder paste. In other words, a sandwich arrangement can be created from the electronic component and the substrate, with the solder paste between the contact surfaces thereof.

In step e), the sandwich assembly can be soldered by heating the solder paste above the liquidus temperature of the solder so that a solid connection is formed between the electronic component and the substrate via the solder paste after the solder has cooled and solidified. The solder paste is preferably heated in such a way that the solder passes into its liquid phase, but without damaging the electronic component and/or the substrate. The sandwich assembly or rather the solder paste is preferably heated to a temperature that is 5 to 60° C., preferably 10 to 50° C., above the liquidus temperature of the solder.

Advantageously, the solder paste comprising the flux according to the invention allows soldering according to step e) in air regardless of the ball size of the solder powder used in the solder paste.

### EXAMPLES

### Preparation of Fluxes and Solder Pastes

The components of the fluxes were combined and homogenized according to Table 1.

To prepare the solder pastes, 11 parts by weight of flux were mixed with 89 parts by weight of solder powder (SnAgCu: Sn 96.5 wt. %, Ag 3.0 wt. %, Cu 0.5 wt. %, type 4 according to the IPC J-STD-005A standard) to form solder pastes.

### Wetting Capacity Under Normal Atmospheric Conditions

The wetting properties of the solder pastes were assessed using the melting test in accordance with the IPC-TM-650 (1/95) test method 2.4.45 under normal atmospheric conditions. For this purpose, the solder pastes to be tested were applied to copper sheets (20 mm×20 mm×0.5 mm). If the copper sheets had an oxide layer on the surface, they were sanded to a bright metallic finish with P600 grit sandpaper and cleaned with alcohol. Copper sheets which had a bright and clean surface were only cleaned with alcohol.

The prepared copper sheets were printed using a stencil. To do this, the template was pressed firmly onto the copper sheet so that the openings in the template were in the middle of the copper sheet. The solder paste to be tested was placed on a Japanese spatula and spread over the openings of the stencil, first lightly and then with a little more pressure, until there was no more solder paste on the stencil. The stencil was then carefully removed while retaining the pattern defined by the stencil. The printed copper sheet was placed on a first 200° C. hot heating plate set at a temperature below the liquidus temperature of the solder for 2 minutes and then immediately placed on a second heating plate set at a temperature 50° C. above the liquidus temperature of the solder. After the solder paste or solder had melted, the copper sheet was left on the second heating plate for another 5 seconds and then removed and cooled down.

After the solder paste had cooled, it was assessed whether it had melted into spots corresponding to the size of the openings in the stencil or into a plurality of small spots, and whether the solder paste had sharp edges after melting. It was also assessed whether the surface was glossy or matt.

The solder pastes were divided into four classes:
Class 1: The remelted area was larger than the area previously printed with solder paste.
Class 2: The remelted surface corresponded to the surface previously printed with solder paste.
Class 3: The remelted area was smaller than the area previously printed with solder paste (slight dewetting visible).
Class 4: The solder paste had formed one or more solder balls and had not wetted the copper sheet or had not completely melted.

### Viscosity Stability Test at Room Temperature

First, the initial viscosity of the freshly prepared solder pastes was determined at 25° C. and a shear rate of 10 s⁻¹ using a plate-plate rheometer (Physica MCR 150 from Anton-Paar; plate diameter 50 mm, measuring gap 400 μm). The solder pastes were then each stored at room temperature (23° C.) in a sealed container and measured again after seven days, as previously stated. Before the viscosity was measured after seven days of storage, each solder paste was briefly mixed homogeneously by hand with a spatula. The difference between the first measured value, which was recorded directly after preparation of the relevant solder paste, and the second measured value in each case, which was recorded after the relevant solder paste had been stored for seven days, was evaluated as follows:

$$++ : < 5 Pa \cdot s + : 5 Pa \cdot s to < 10 Pa \cdot s - :> 10 Pa \cdot s$$

TABLE 1
Composition of fluxes 1 to 3 according to the invention and
comparative fluxes V1 and V2 as well as measurement results:

| Flux | 1 | 2 | 3 | V1 | V2 |
|---|---|---|---|---|---|
| (Meth)acrylic copolymer 1 | 40 | — | — | — | — |
| M_{W} 1800, SZ 244 mg KOH/g, | | | | | |
| T_{g} 57° C. | | | | | |
| (Meth)acrylic copolymer 2 | — | 40 | — | — | — |
| M_{W} 1900, SZ 250 mg KOH/g, | | | | | |
| T_{g} 88° C. | | | | | |
| (Meth)acrylic copolymer 3 | — | — | 40 | — | — |
| M_{W} 3000, SZ 185 mg KOH/g, | | | | | |
| T_{g} 76° C. | | | | | |
| (Meth)acrylic copolymer 4 | — | — | — | 40 | — |
| M_{W} 6900, SZ 220 mg KOH/g, | | | | | |
| T_{g} 105° C. | | | | | |
| Colophony | — | — | — | — | 40 |
| M_{W} 375, SZ 150 mg KOH/g | | | | | |
| Dodecanedioic acid | 3.5 | 3.5 | 3.5 | 3.5 | 3.5 |
| Benzilic acid | 3.5 | 3.5 | 3.5 | 3.5 | 3.5 |
| N,N,N′,N′- | 10 | 10 | 10 | 10 | 10 |
| tetramethylethylenediamine | | | | | |
| Diethylene glycol monohexyl ether | 40 | 40 | 40 | 40 | 40 |
| Thickener (Disparlon | 3 | 3 | 3 | 3 | 3 |
| 6500 from King Industries) | | | | | |
| Acid number of the | 120 | 123 | 100 | 118 | 105 |
| flux FMSZ (mg KOH/g) | | | | | |
| Wetting capacity | 2 | 2 | 3 | 3 | 4 |
| Viscosity stability | ++ | ++ | ++ | − | + |

What is claimed is:

1. A flux, consisting of:
(i) 30 to 80 wt. % of one or more acidic (meth)acrylic copolymers having an acid number in the range from 100 to 350 mg KOH/g and having a weight-average molecular weight M_{w} in the range from 1000 to 5000;
(ii) 10 to 60 wt. % of at least one organic solvent;
(iii) 0 to 15 wt. % of one or more amines; and,
(iv) 0 to 20 wt. % of one or more components other than components (i) to (iii).

2. The flux according to claim 1, wherein the acid number is in the range from 150 to 300 mg KOH/g and the weight average molecular weight M_{w} is in the range from 1000 to 3000.

3. The flux according to claim 1, wherein the acidic (meth)acrylic copolymer(s) have a glass transition temperature (T_{g}) in the range from >0° C. to <105° C.

4. The flux according to claim 1, wherein the flux has a flux acid number (FMSZ) in the range from 100 to 250 mg KOH/g.

5. A solder paste consisting of 80 to 92 wt. % of one or more different solders and 8 to 20 wt. % of a flux according to claim 1.

6. A use of a solder paste according to claim 5 for connecting electronic components to substrates or for producing solder deposits on substrates.
